(19) United States
(12) Patent Application Publication
(10) Pub. No.: US 2003/0052768 A1
(43) Pub. Date: Mar. 20, 2003

(54) Security method and system

(76) Inventor: James J. Maune, Plainview, NY (US)

Correspondence Address: BAKER & BOTTS, 30 ROCKEFELLER PLAZA, NEW YORK, NY, 10112

(21) Appl. No.: 10/245,543

(22) Filed: Sep. 17, 2002

Related U.S. Application Data
(60) Provisional application No. 60/322,836, filed on Sep. 17, 2001.

(51) Int. Cl. G06F 7/04

(52) U.S. Cl. 340/5.53; 340/5.52

(57) ABSTRACT

An access control system is provided wherein identification data such as a photograph is downloaded from a trusted authority to a security system. Security personnel can then compare the person seeking access to an image of the person as sent by the trusted authority, and avoid reliance on identification documents presented by the person seeking access.

### BACKGROUND OF THE INVENTION

This application claims the benefit of Provisional Application No. 60/322,836, filed Sep. 17, 2001.

This invention relates to security checking of persons seeking to gain access to a facility. An example is access to an airport or departure gate wherein persons are checked for identification before entry is permitted. Other applications include access to industrial or government facilities.

A major difficulty of current security systems is that access is granted or denied on the basis of documentation presented by the person seeking access, such as a drivers license, state issued identification or a passport. Such documentation is issued by many agencies, for example all fifty of the United States have agencies for issuing such documentation, all of which take different form. Passports are issued by virtually all countries of the world, also in varying form. Accordingly, it becomes difficult for a person administering security, for example at an airport, to distinguish a validly issued document from one which is counterfeit. The ability to distinguish counterfeit documentation is further complicated by the fact that computer technology has made the counterfeiting process easier, for example using imaging technology on a personal computer it is easily possible to create false identification using an image scanned from stolen documents on which portions are digitally changed, such as by changing a photo image.

It is an object of the current invention to provide improved security access methods and systems wherein identification information is provided to the access control point independent of documentation provided by the person seeking access.

### SUMMARY OF THE INVENTION

In accordance with the invention there is provided a method for controlling access to a secured area. Biometric data is provided and stored in a database operated by a trusted authority, the stored biometric data being associated with data identifying a person. The stored biometric data is transferred from the database to a security computer in response to a request, the request including the identification data. The biometric data is read from the security computer and used to verify the identity of a person seeking access.

In a preferred arrangement, the stored biometric data comprises stored photographic image data. The image data is displayed and compared to a person seeking access. Additional data may be stored and provided with the biometric data. The additional data is related to a person identified by the biometric data, and can be used in the security computer for evaluating the trustworthyness of a person. Data can be transferred to the security computer in response to a transfer request made in advance of an access request by the person. The biometric data can be provided and stored in connection with government records identifying persons. Alternately the biometric data can be obtained from government records identifying persons and transferred to another trusted source computer.

For a better understanding of the present invention, together with other and further objects, reference is made to the following description, taken in conjunction with the accompanying drawings, and its scope will be pointed out in the appended claims.

### BRIEF DESCRIPTION OF THE DRAWINGS

FIG. 1 is a block diagram illustrating a system in accordance with a first embodiment of the invention.

FIG. 2 is a block diagram illustrating a system in accordance with a second embodiment of the invention.

### DESCRIPTION OF THE INVENTION

The present invention is based on the recognition that the reliability of documentation presented for acceptance for purposes of security access is much higher if the documentation and the validity thereof is confirmed independently of the documentation presented for acceptance. For example, in the field of credit card transactions, it is routine for a merchant to whom a credit card is presented for payment to verify the authenticity of the card by electronic communication with the issuer of the card, to verify that it is validly issued and has not been reported stolen. This independent verification of the document presented (the credit card) provides a high degree of security in accepting the card for payment.

In the field of access control, persons seeking access to secured areas, such as airports or industrial facilities, are likewise requested to present some form of photo identification, such as a drivers license or photograph. While it is conceivable to perform electronic communication to verify from an issuing authority whether the document is authentic, the documentation presented may bear the same name, number and other data as an authentic document, and bear the photo image of the person presenting the document, which is not the person to whom the document was issued. Verification of the photographic image by electronic transmission, while technically possible, requires electronic access to the issuing authority and may result in delays in retrieving and transmitting image data. In many situations, such as airport access, the required delays would be impractical.

The present invention is based further on a recognition that most people seeking access, for example to an airline flight, are legitimate travelers and are willing to cooperate in the security process. Taking advantage of this recognition, the system and method of the invention provides an advantage of speedy security processing for persons cooperating with the security process in advance. Such cooperation may be through a regular (trusted traveler) program, or for a single access occasion. People seeking access are given an incentive to provide cooperation with the system, by a lower level of hassle at the security checkpoint, and the processing of such cooperating persons lowers the overall burden on security personnel, so that they may concentrate on reviewing the unconfirmed paper documentation presented by others.

In accordance with one aspect of the invention people seeking access, who are participating in the process, provide information in advance of their access request, which enables the pre-loading of security information into a system that is available at the point of access.

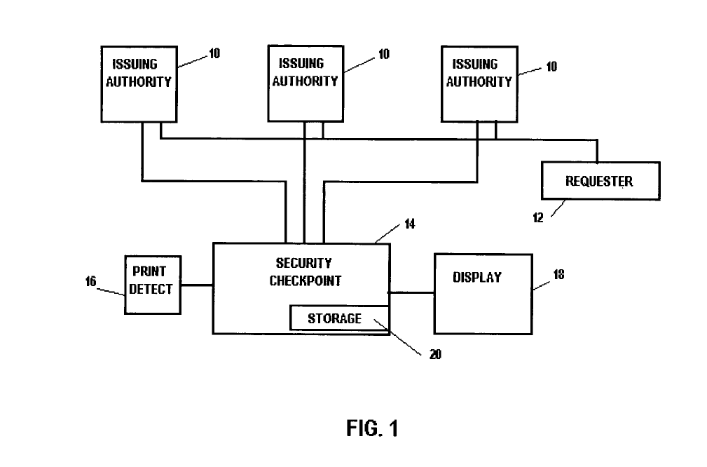

In one example, illustrated in FIG. 1, there is provided a system for downloading of identification data from one of a number of issuing authorities 10, such as a national passport administration or state motor vehicle bureau, to a server 14 which provides data at a security checkpoint. The data is downloaded in response to a request by a requester 12, which may, for example, be an airline or the security department of an industrial facility. Alternately the requester may be the passenger or the person seeking access, such as a visitor to the facility.

The method of the first embodiment may be practiced by requesting security information, such as the state and license number of a driver's license from a passenger at the time a passenger makes a flight reservation. In this case the requester is the airline, which directly communicates with an issuing authority, such as the New York State Department of Motor Vehicles, in an electronic request for identification data, in particular biometric data, such as a photograph, fingerprint or retinal scan, corresponding to the license number of the passenger. In response to this request the issuing authority downloads the requested data as an electronic file, which the airline can store, for example in storage 20 in a server 14 that provides checkpoint security at the departure airport. When the passenger arrives at the airport, security can rapidly verify his identity by comparing, for example, a photo of the passenger, displayed on display 18, which has been directly obtained from the Department of Motor Vehicles to the face of the person seeking access. Since the photo is obtained directly from the issuing authority, and not from documents presented by the passenger, there is a greater confidence that the identification is authentic.

Other identification data may also be used for verification, such as fingerprints or retinal scan data. Fingerprint or retinal scan data may be downloaded instead of, or in addition to, photo data and compared to the fingerprint or retinal scan of a person detected electronically by detector 16.

As an additional feature, and for purposes of providing an evaluation of the bono-fides of a person seeking access, additional data may be received from the trusted authority, such as the Department of Motor Vehicles. The additional data may be an indication of how long the person has been licensed by the state, so that persons of long standing identification may be rated as more trustworthy than those who were only recently licensed.

In a modification of the first embodiment, a passenger may request downloading of identification data without a reservation, either directly or via the airline. This may be appropriate in the case of business travelers who may use shuttle flights or fly without advance reservation, or who may seek to change flights at the last minute. In such case the passenger may request identification data download for a flight from Dallas on November 14 or 15.

By pre-transmission of identification data such as photographic data from a trusted authority, security personnel can receive better guidance in selecting passengers to receive special screening. The special screening on a random basis or on criteria not related to risk has been the subject of criticism of security measures. Where people are willing to have their data provided to the security system via an independent trustworthy source in advance, they may be removed from the categories of persons given special screening, thereby reducing screening resources. The selection of persons for special screening has thus far been observed to follow criteria not related to risk, such as last minute changes in flight plan, even when the change is made by the airline. The provision of independent photographic identification, possibly coupled with other data, such as long time licensing by a state can reduce the subjects for special screening and enable security resources to be better utilized.

In addition to the direct communication of identification data from the issuing authority the time-advanced transfer of security data has other advantages. For example the Security Checkpoint server 14 may compare the identification data against lists of suspects derived or provided by law enforcement agencies in advance of check-in, making the process quicker and providing greater security

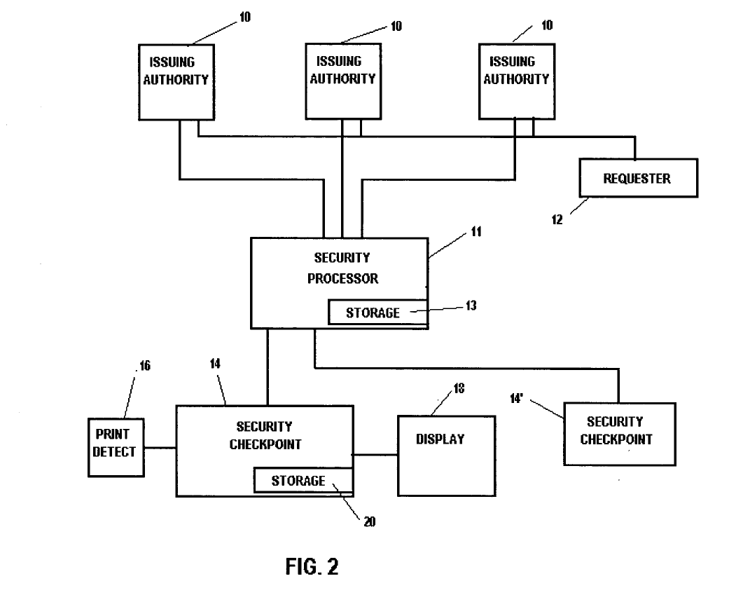

FIG. 2 is a block diagram of a variation of the invention wherein data from issuing authorities is gathered in a security processor 11 having data storage 13. Security processor 11 gathers data in advance on a permanent or ad hoc basis and provides it to checkpoint processors 14 and 14′, for example by high speed data transfer.

It will be recognized that the pre-stored identification data, such as a digital photo, can be retrieved by the checkpoint processor in response to entry of data identifying the passenger, such as by reading bar codes on tickets, drivers license or by entry of a passenger's name. Since the data has been pre loaded, it can be retrieved from a relatively small data base rapidly, either locally or by high speed communication with a security server 11. In practice at an airport the data can be pre-associated with an electronic ticket or a person's reservation prior to check in. In such case, the check in agent would merely scan or enter the data for the electronic ticket and retrieve the image of the passenger.

Passengers who have provided advance security data can be processed rapidly, for example at express check in stations, while other passengers, whose identification has not been subject to prior downloading, or which has been issued by an authority that does not participate, may be subjected to more burdensome security questioning and processing.

In one possible arrangement, passengers boarding an airline may be subjected to initial screening, which allows passengers with pre-loaded and acceptable identification data to proceed to boarding, while those without pre-loaded data are subjected to further, more detailed screening based on documentation presented.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

I claim:

1. A method for controlling access to a secured area, comprising:
providing stored biometric data in a database operated by a trusted authority, said stored biometric data being associated with data identifying a person;
transferring said stored biometric data from said database to a security computer in response to a request, said request including said identification data; and
retrieving said biometric data from said security computer and using said biometric data to verify the identity of a person seeking access.

2. A method as specified in claim 1, wherein said providing stored biometric data comprises providing stored photographic image data.

3. A method as specified in claim 2, wherein said using said biometric data comprises displaying said photographic image and comparing said image to said person seeking access.

4. A method as specified in claim 2 further comprising providing additional data with said stored biometric data, said additional data related to a person identified by said biometric data, and using said additional data in said security computer for evaluating the trustworthyness of said person.

5. A method as specified in claim 1 wherein said transferring is in response to a transfer request made in advance of an access request by said person.

6. A method as specified in claim 1 wherein said providing stored biometric data comprises providing said data in connection with government records identifying persons.

7. A method as specified in claim 1 wherein said providing stored biometric data comprises obtaining said data from government records identifying persons.
